(19) United States
(12) Patent Application Publication
(10) Pub. No.: US 2025/0293353 A1
(43) Pub. Date: Sep. 18, 2025

(54) SECONDARY BATTERY

(71) Applicant: Samsung SDI Co., Ltd., Yongin-si (KR)

(72) Inventor: Min Ja Cheon, Yongin-si (KR)

(73) Assignee: Samsung SDI Co., Ltd., Yongin-si (KR)

(21) Appl. No.: 18/904,306

(22) Filed: Oct. 2, 2024

(30) Foreign Application Priority Data
Mar. 15, 2024 (KR) 10-2024-0036373

(51) Int. Cl. H01M 50/105; H01M 50/103; H01M 50/119; H01M 50/176; H01M 50/178

(52) U.S. Cl. CPC H01M 50/105; H01M 50/103; H01M 50/119; H01M 50/176; H01M 50/178; H01M 2220/20

(57) ABSTRACT

Embodiments relate to a secondary battery that prevents an electrode body from moving inside a housing when dropped. A secondary battery includes a housing including a first case and a second case coupled to the first case, an electrode body accommodated in the housing, and a lead tab exposed outward from the electrode body to the outside through one side of the housing. At least one of the first case or the second case of the case includes a movement prevention part configured to prevent the electrode body from moving.

### CROSS-REFERENCE TO THE RELATED APPLICATIONS

This present application claims priority to and the benefit under 35 U.S.C. § 119 (a)-(d) of Korean Patent Application No. 10-2024-0036373, filed on Mar. 15, 2024, in the Korean Intellectual Property Office, the entire disclosure of which is incorporated herein by reference.

### FIELD

Embodiments relate to a secondary battery. BACKGROUND

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure provide a secondary battery that prevents an electrode body from moving inside a case when dropping.

These and other aspects and features of the present disclosure will be described in or will be apparent from the following description of embodiments of the present disclosure.

According to some embodiments, a secondary battery includes: a housing including a first case and a second case, the second case coupled to the first case; an electrode body accommodated in the housing; and a lead tab protruding outward from the electrode body, through one side of the housing, to the outside of the housing, wherein at least one of the first case or the second case includes a movement prevention part configured to prevent the electrode body from moving.

In one or more embodiments, the movement prevention part may be provided on a partial area of the housing corresponding to a perimeter of the electrode body.

In one or more embodiments, the movement prevention part may include a dimple or an embossing that protrudes toward the inside of the housing.

In one or more embodiments, the movement prevention part may be provided in the form of a dotted line, a dashed line, a long-dashed line, a dash-single dotted line, and/or a dash-double dotted line.

In one or more embodiments, the movement prevention part may be provided such that the movement prevention part crosses the electrode body.

In one or more embodiments, at least two lines of the movement prevention part may be provided such that the at least two lines of the movement prevention part cross the electrode body.

In one or more embodiments, the housing may include: a case first area extending in a first direction; and a case second area extending in a second direction perpendicular to the first direction.

In one or more embodiments, the electrode body may include: an electrode body first area accommodated in the case first area; and an electrode body second area accommodated in the case second area.

In one or more embodiments, the movement prevention part may be provided along a perimeter of the sum of the case first area and the case second area.

In one or more embodiments, the movement prevention part may include: a first movement prevention part provided along a perimeter of the case first area; and a second movement prevention part spaced apart from the first movement prevention part and provided along a perimeter of the case second area.

In one or more embodiments, the movement prevention part may be provided on either of the case first area or the case second area.

In one or more embodiments, the movement prevention part may include: a first movement prevention part provided on the case first area from which the lead tab is withdrawn; and a second movement prevention part provided on the case second area without the lead tab, wherein a protruding thickness of the first movement prevention part may be greater than a protruding thickness of the second movement prevention part.

In one or more embodiments, the first movement prevention part may extend from a partial area of the case first area to a partial area of the case second area.

In one or more embodiments, the housing may include stainless steel.

In one or more embodiments, the first case may include a first flange provided along a perimeter thereof; and a second case may include a second flange provided along a perimeter thereof, wherein the first flange and the second flange may be welded to each other.

Certain aspects of the present disclosure generally relate to methods of manufacturing a secondary battery. In some embodiments, a method of manufacturing a secondary battery comprises positioning an electrode body in a housing comprising a first case and a second case, wherein: the second case is coupled to the first case; at least one of the first case or the second case comprises a movement prevention part configured to prevent the electrode body from moving; and a lead tab protrudes outward from the electrode body, through one side of the housing, to the outside of the housing.

In some embodiments, the movement prevention part is provided on a partial area of the housing corresponding to a perimeter of the electrode body.

In some embodiments, the movement prevention part comprises a dimple or an embossing that protrudes toward the inside of the housing.

In some embodiments, the movement prevention part is provided in the form of a dotted line, a dashed line, a long-dashed line, a dash-single dotted line, and/or a dash-double dotted line.

In some embodiments, the housing comprises a case first area extending in a first direction; and a case second area extending in a second direction perpendicular to the first direction.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings: FIG. 1A illustrates a plan view of a secondary battery, according to some embodiments;

FIG. 1B illustrates an exploded perspective view of the secondary battery, according to some embodiments;

FIG. 1C illustrates a cross-sectional view taken along line 1C-1C of FIG. 1A, according to some embodiments;

FIG. 2 illustrates a plan view of a secondary battery, according to some embodiments;

FIG. 3 illustrates a plan view of a secondary battery, according to some embodiments;

FIG. 4 illustrates a plan view of a secondary battery, according to some embodiments;

FIG. 5 illustrates a plan view of a secondary battery, according to some

embodiments;

FIGS. 6A and 6B illustrate perspective views of a battery pack including the secondary battery according to some embodiments; and

FIGS. 7A and 7B illustrate perspective and side views of a vehicle including the battery pack according to some embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

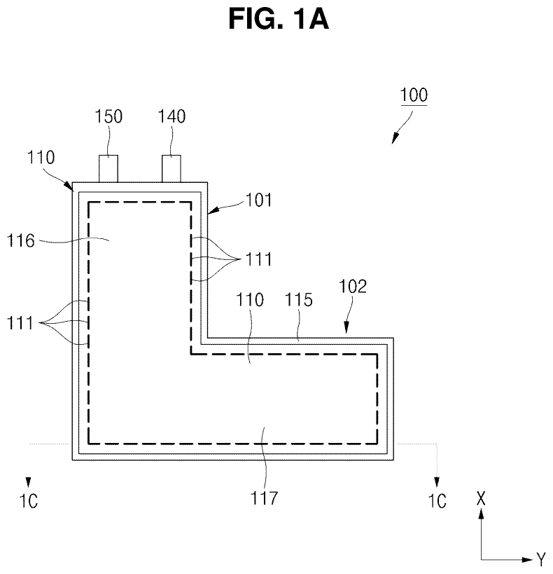

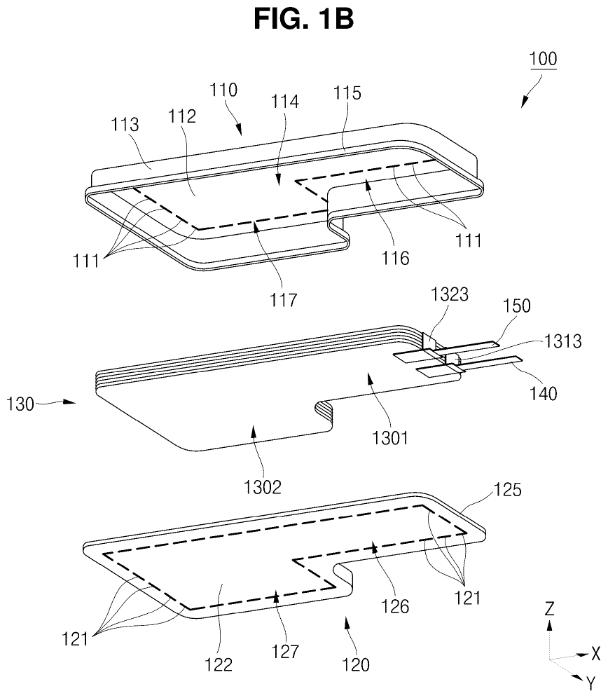

FIG. 1A illustrates a plan view of a secondary battery according to some embodiments, FIG. 1B illustrates an exploded perspective view of the secondary battery according to some embodiments, and FIG. 1C illustrates a cross-sectional view taken along line 1C-1C of FIG. 1A. As illustrated in FIGS. 1A to 1C, a secondary battery 100 according to some embodiments may include a first case 110, a second case 120, and an electrode body 130. The secondary battery 100 according to embodiments may further include movement prevention part(s) 111 and 121 provided in the first case 110 and/or the second case 120. In some embodiments, the secondary battery 100 according to embodiments may further include a first lead tab 140 and a second lead tab 150, which are connected to the electrode body 130 to extend outward through the first case 110 and the second case 120, respectively.

The first case 110 may include a flat part (e.g., roof) 112 and a sidewall 113. The flat part 112 may be provided to be substantially flat, and the sidewall 113 may be provided to extend substantially downward from a perimeter of the flat part 112. In one or more embodiments, a recess 114 may be defined by the flat part 112 and the sidewall 113. The first case 110 may include or be referred to as a case, a can, a pouch, an exterior, or a housing. In one or more embodiments, the first case 110 may further include a first flange 115 that is horizontally oriented along a lower end of the sidewall 113 and bent in an outward direction. In one or more embodiments, a planar shape of the first case 110 may be provided in an approximately “L” shape. In one or more embodiments, an area extending in a first direction (e.g., X direction) of the first case 110 may be defined as a first case first area 116, and an area extending in a second direction (e.g., Y direction) substantially perpendicular to the first direction may be defined as a first case second area 117. In one or more embodiments, the first case 110 may include a metal such as steel, stainless steel, nickel-plated steel, a metal such as a cold thin plate for deep drawing (SPCE) or aluminum, and/or a laminated film or plastic. In one or more embodiments, a method for manufacturing a first case 110 may include a metal sheet preparation process of preparing a metal sheet, a metal sheet cutting process of cutting the metal sheet to a predetermined length, a preform forming process of forming a concave part having a thickness less than that of a peripheral portion on a central area of a top surface of the cut metal sheet to form a preform; and a punching process of punching a top surface of the preform in a downward direction, and a scrap removing process of removing a scrap that is an unnecessary portion. In one or more embodiments, a first case 110 including a flat part 112 and a sidewall 113 constituting a recess 114, and a first flange 115 extending in an outer horizontal direction from the sidewall 113 may be manufactured through the punching process and the scrap removing process.

The first case 110 may include movement prevention part(s) 111 provided in the flat part 112. The movement prevention part 111 may be provided in a partial area of the flat part 112 corresponding to a perimeter of an electrode body 130. In one or more embodiments, the movement prevention part 111 may be provided generally along a perimeter of the flat part 112 of the first case 110. In one or more embodiments, the movement prevention part 111 may be provided in a generally closed curve shape along the perimeter of the flat part 112 of the first case 110. In one or more embodiments, the movement prevention part 111 may protrude or recess toward the electrode body 130.

An apex of the movement prevention part 111 may be in contact with the electrode body 130. In one or more embodiments, the movement prevention part 111 may be in contact with a separator, an insulating film, or an insulating tape disposed at the outermost side of the electrode body 130. In one or more embodiments, the movement prevention part 111 may be provided in the form of a dotted line, a dashed line, a long-dashed line, a dash-single dotted line, and/or a double-dotted line. In one or more embodiments, a depth of the movement prevention part 111 may be approximately 1 mm to approximately 10 mm. In one or more embodiments, a depth of each of the plurality of movement prevention parts 111 may be approximately 1 mm to approximately 10 mm. In one or more embodiments, a protruding thickness (including a depth or width) of the movement prevention part 111 may be approximately 1 mm to approximately 10 mm. In one or more embodiments, the movement prevention part 111 may include or be referred to as a dimple, an embossing, a groove, or a recess. In one or more embodiments, a thickness of the movement prevention part 111 itself may be similar to or equal to that of an outer area of the movement prevention part 111. In one or more embodiments, the movement prevention part 111 may be provided in a first case first area 116 and/or a first case second area 117. In one or more embodiments, the movement prevention part 111 may be provided on a perimeter of the first case first area 116 and/or a perimeter of the first case second area 117. In one or more embodiments, the movement prevention part 111 may be provided along a perimeter of the sum of the first case first area 116 and/or the first case second area 117. In some embodiments, the movement prevention part(s) 111 may be manufactured together by the above-described punching process. In one or more embodiments, a protrusion having a shape opposite to the of the movement prevention part(s) 111 may be provided on a die used in the above-described punching process to provide the movement prevention part(s) 111 on the flat part 112 in the punching process.

In one or more embodiments, a partial area of the first case 110 on which the movement prevention part(s) 111 is not formed may be spaced apart from an electrode assembly 130. In some embodiments, a gap may exist between a partial area of the first case 110 on which the movement prevention part(s) 111 is not formed and the electrode assembly 130, and the gap may absorb (e.g., accommodate) a certain degree during swelling.

The second case 120 may be provided in a generally flat shape. The second case 120 may include or be referred to as a case, a can, a pouch, an exterior, or a housing. In one or more embodiments, an area extending in a horizontal outward along a perimeter of the second case 120 may be defined as a second flange 125. In one or more embodiments, a planar shape of the second case 120 may be provided in an approximately “L” shape similar to or equal to the planar shape of the first case 110. In one or more embodiments, an area extending in the first direction of the second case 120 may be defined as a second case first area 126, and an area extending in the second direction that is approximately perpendicular to the first direction may be defined as a second case second area 127. In one or more embodiments, the second case first area 126 may correspond to (overlap) the first case first area 116, and the second case second area 127 may correspond to (overlap) the first case second area 117. In one or more embodiments, the second case 120 may include a metal such as steel, stainless steel, nickel-plated steel, a metal such as a cold thin plate for deep drawing (SPCE) or aluminum, and/or a laminated film or plastic. In one or more embodiments, the shape (e.g., two-dimensional or three-dimensional shape) of the second case 120 may be similar or equal to the shape of the first case 110. In one or more embodiments, the second case 120 may include a recess defined by the flat part (e.g., bottom portion) and a sidewall. In one or more embodiments, the method for manufacturing the second case 120 may be similar or equal to the method for manufacturing the first case 110.

The second case 120 may include movement prevention part(s) 121 provided in the flat part 122. The movement prevention part 121 may be substantially provided in a partial area of the flat part 122 corresponding to a perimeter of an electrode body 130. In one or more embodiments, the movement prevention part 121 may be provided generally along a perimeter of the flat part 122 of the second case 120. In one or more embodiments, the movement prevention part 121 may be provided in a generally closed curve shape along the perimeter of the flat part 122 of the second case 120. In one or more embodiments, the movement prevention part 121 may protrude or recess toward the electrode body 130. An apex of the movement prevention part 121 may be in contact with the electrode body 130. In one or more embodiments, the movement prevention part 121 may be provided in the form of a dotted line, a dashed line, a long-dashed line, a dash-single dotted line, or a double-dotted line. In one or more embodiments, a depth of the movement prevention part 121 may be approximately 1 mm to approximately 10 mm. In one or more embodiments, a depth of each of the plurality of movement prevention parts 121 may be approximately 1 mm to approximately 10 mm. In one or more embodiments, a protruding thickness (including a depth or width) of the movement prevention part 121 may be approximately 1 mm to approximately 10 mm. In one or more embodiments, the movement prevention part 121 may include or be referred to as a dimple, an embossing, a groove, or a recess. In one or more embodiments, a thickness of the movement prevention part 121 itself may be similar to or equal to that of an outer area of the movement prevention part 121. In one or more embodiments, the movement prevention part 121 may be provided in a second case first area 126 and/or a second case second area 127. In one or more embodiments, the movement prevention part 121 may be provided on a perimeter of the second case first area 126 and/or a perimeter of the second case second area 127. In one or more embodiments, the movement prevention part 121 may be provided along a perimeter of the sum of the second case first area 126 and/or the second case second area 127. A method for manufacturing the movement prevention part 121 may be similar or equal to the method for manufacturing the movement prevention part 111 described above.

In one or more embodiments, a partial area of the second case 120 on which the movement prevention part(s) 121 is not formed may be spaced apart from an electrode assembly 130. In some embodiments, a gap may exist between a partial area of the second case 120 on which the movement prevention part(s) 121 is not formed and the electrode assembly 130, and the gap may absorb (e.g., accommodate) a certain degree during swelling.

In one or more embodiments, the movement prevention parts 111 and 121 may

be provided in at least one of the first case 110 or the second case 120. In one or more embodiments, the movement prevention parts 111 and 121 may be provided in both the first case 110 and the second case 120, respectively. In one or more embodiments, the movement prevention parts 111 and 121 may be provided in opposing areas of the first case 110 and the second case 120. In one or more embodiments, the movement prevention parts 111 and 121 may be provided in non-opposing areas of the first case 110 and the second case 120. In one or more embodiments, the movement prevention parts 111 and 121 may correspond to the perimeter of the electrode body 130 and also be provided on opposing areas of the first case 110 and the second case 120. In one or more embodiments, the movement prevention parts 111 and 121 may correspond to the perimeter of the electrode body 130 and also be provided on non-opposing areas of the first case 110 and the second case 120.

In one or more embodiments, the first flange 115 may be coupled to the second flange 125 to provide one case in which the electrode body 130 is sealed or accommodated in a space between the first case 110 and the second case 120. Similar to the above, the case may include or be referred to generically as a metal case, a metal can, an SUS can, a housing, and/or an exterior.

In one or more embodiments, the first flange 115 of the first case 110 may be coupled to the second flange 125 of the second case 120 through various methods such as laser welding, arc welding, electric resistance welding, gas welding, and/or friction welding.

The electrode body 130 may be provided by stacking or winding a stack of a first electrode plate 131 and a second electrode plate 132, each of which is provided in a thin plate shape or film shape, and a separator 133 between the first and second electrode plates 131 and 132. The electrode body 130 may include or be referred to as an electrode assembly, an electrode group, electrodes, an electrode element, a stack, a jelly roll, and/or a cell. In one or more embodiments, the electrode body 130 may be a Z-stack electrode body in which a positive electrode plate and a negative electrode plate are inserted into both sides of the separator 133 that is bent into a Z-stack. In some embodiments, the electrode body 130 may be accommodated or sealed in a space between the first case 110 and the second case 120 by stacking one or more electrode bodies so that their long sides are adjacent to each other. In one or more embodiments, the first electrode plate 131 of the electrode body 130 may serve as a negative electrode, and the second electrode plate 132 may serve as a positive electrode, and vice versa (e.g., the first electrode plate 131 of the electrode body 130 may serve as a positive electrode, and the second electrode plate 132 may serve as a negative electrode).

The first electrode plate 131 may include a plurality of first electrode tabs 1313 that are provided by applying a first electrode active material 1312 (or negative electrode active material) such as graphite and/or carbon on a first electrode current collector plate 1311 made of metal foil such as copper, a copper alloy, nickel and/or a nickel alloy and are not coated with the first electrode active material 1312. In one or more embodiments, the first electrode current collector plate 1311 may be referred to as a first electrode base material, and the first electrode tab 1313 may be referred to as a first base material tab or a first non-coating portion tab. The first electrode tab 1313 may serve as a path for a current flow between the first electrode plate 131 and the first lead tab 140. In one or more embodiments, the first electrode tab 1313 may be provided by notching or cutting the first electrode plate 131 such that the first electrode tab 1313 protrudes to one side in advance when manufacturing the first electrode plate 131 and also may further protrude to one side of the separator 133 without performing separate cutting.

The second electrode plate 132 may include a second electrode tab 1323 that is provided by applying a second electrode active material 1322 (positive electrode active material) such as transition metal oxide to the second electrode current collector 1321 made of metal foil such as aluminum and/or an aluminum alloy and is not coated with the second electrode active material. In one or more embodiments, the second electrode current collector plate 1321 may be referred to as a second electrode base material, and the second electrode tab 1323 may be referred to as a second base material tab or a second non-coating portion tab. The second electrode tab 1323 may serve as a path for a current flow between the second electrode plate 132 and the second lead tab 150. In one or more embodiments, the second electrode tab 1323 may be provided by notching or cutting the second electrode plate 132 such that the second electrode tab 1323 protrudes to one side in advance when manufacturing the second electrode plate 131 and also may further protrude to one side of the separator 133 without performing separate cutting.

In some embodiments, the first electrode tab 1313 of the first electrode plate and the second electrode tab 1323 of the second electrode plate 132 may be disposed to be spaced apart from each other at one end of the electrode body 130. In one or more embodiments, the electrode body 130 may be accommodated in an internal space provided between the first case 110 and the second case 120 together with an electrolyte. In some embodiments, the plurality of first electrode tabs 1313 and the plurality of second electrode tabs 1323 may be welded and/or connected to the first lead tab 140 and the second lead tab 150, respectively.

In one or more embodiments, the first lead tab 140 and the second lead tab 150 may extend outward from the internal space provided by the first case 110 and the second case 120, respectively. The first lead tab 140 and the second lead tab 150 may also be disposed to be spaced apart from each other similarly to the first electrode tab 1313 and the second electrode tab 1323. In one or more embodiments, the first lead tab 140 may include metal foil such as copper, a copper alloy, nickel, and/or a nickel alloy. In one or more embodiments, the second lead tab 150 may include metal foil such as aluminum and/or an aluminum alloy. In one or more embodiments, a first sealing insulating tape (not shown) may be interposed between areas of the first lead tab 140 that overlaps the first case 110 and the second case 120, and also, a second sealing insulating tape (not shown) may be interposed between areas of the second lead tab 150 that overlaps the first case 110 and the second case 120. In one or more embodiments, the first and second sealing tapes may comprise polypropylene, polyethylene, and/or ethylene-propylene-dienter polymer (EPDM) that does not react with the electrolyte.

In one or more embodiments, the planar shape of the electrode body 130 may be provided in an approximately “L” shape similar to or equal to the planar shape of each of the first case 110 and the second case 120. In one or more embodiments, the electrode body 130 may include an electrode body first area 1301 accommodated in an internal space between the first case first area 116 and the second case first area 126 and an electrode body second area 1302 accommodated in an internal space between the first case second area 117 and the second case second area 127. In one or more embodiments, the first electrode tab 1313 and the second electrode tab 1323 may be provided on the electrode body first area 1301.

In one or more embodiments, the first case first area 116 and the second case first area 126 may be defined as a first battery area 101, and the first case second area 117 and the second case second area 127 may be defined as a second battery area 102. In one or more embodiments, the first case first area 116, the second case first area 126, and the electrode body first area 1301 may be defined as a first battery area 101, and the first case second area 117, the second case second area 127, and the electrode body second area 1302 may be defined as a second battery area 102.

As described above, the present disclosure may provide a movement prevention part in the form of the dotted line and protruding toward the electrode body at the portion of the case corresponding to the perimeter of the electrode body to prevent the electrode body from moving inside the case when the secondary battery drops. Therefore, the electrode body may be prevented from moving inside the case when dropped such that fires due to the internal short circuit of the electrode body may be prevented from occurring.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b>0.5, 0<c<0.05); LiₐNi_{1-b-c}CO_{b}X_{c}O_{2-α}D_{α} (0.90<a≤1.8, 0≤b≥0.5, 0<c≤0.5, 0<α<2); LiₐNi_{1-b-c}Mn_{b}X_{c}0_{2-α}D_{α} (0.90≤a≤1.8, 0≤b≤0.5, 0≤c≤0.5, 0<α<2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ(0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The various secondary batteries 100A, 100B, 100C, and 100D described below may share characteristics of the secondary battery 100 described above, unless otherwise specified. In some embodiments, it should be noted that the thickness of the movement prevention part described below refers to a depth, a length and/or a width unless otherwise specified.

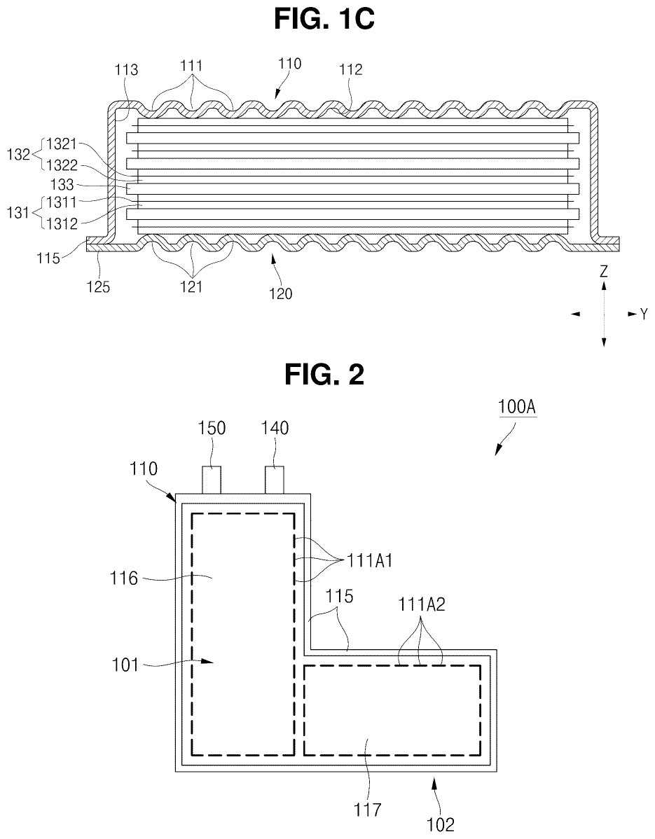

FIG. 2 illustrates a plan view of a secondary battery 100A according to embodiments. As illustrated in FIG. 2, in the secondary battery 100A according to embodiments, a case may include a case first area 101 extending in a first direction and a case second area 102 extending in a second direction that is substantially perpendicular to the first direction, and a movement prevention part may include a first movement prevention part 111A1 provided generally along a perimeter of the case first area 101 and a second movement prevention part 111A2 provided generally along a perimeter of the case second area 102. In one or more embodiments, the first movement prevention part 111A1 and the second movement prevention part 111A2 may be simultaneously provided on a boundary area between the case first area 101 and the case second area 102. In one or more embodiments, two lines of the first movement prevention part 111A1 and the second movement prevention part 111A2 may cross each other in a direction generally parallel to a longitudinal direction of the case first area 101 to cross the electrode body 130. In one or more embodiments, two lines of the first movement prevention part 111A1 and the second movement prevention part 111A2 may cross the electrode body 130 in a direction that is substantially perpendicular to a longitudinal direction of the case second area 102. In one or more embodiments, the first movement prevention part 111A1 and the second movement prevention part 111A2 may be provided independently from each other and thus may be spaced apart from each other.

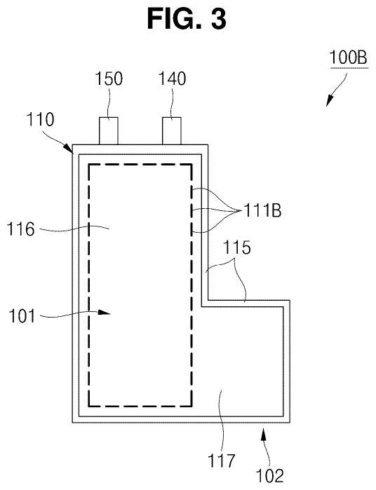

FIG. 3 illustrates a plan view of a secondary battery 100B according to embodiments. As illustrated in FIG. 3, in the secondary battery 100B according to embodiments, a case may include a case first area 101 extending in a first direction and a case second area 102 extending in a second direction that is substantially perpendicular to the first direction, and a movement prevention part 111B may be provided on a perimeter of the case first area 101. In one or more embodiments, the case second area 102 may not be provided with the movement prevention part. In one or more embodiments, a surface area of the case first area 101 may be greater than that of the case second area 102. In one or more embodiments, the movement prevention part may be provided on the case first area 101, which has a relatively large area, and the movement prevention part may not be provided on the case second area 102, which has a relatively small area. In one or more embodiments, the movement prevention part 111B may have a substantially square closed curve shape.

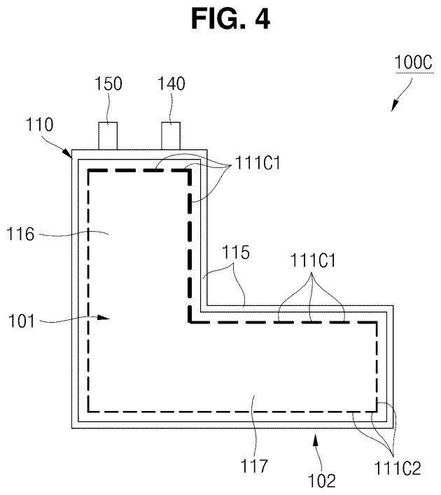

FIG. 4 illustrates a plan view of a secondary battery 100C according to embodiments. The secondary battery 100C illustrated in FIG. 4 may be similar to the secondary battery 110 illustrated in FIG. 1A. However, a protruding thickness of the movement prevention part may be configured differently depending on the area of the case. In one or more embodiments, a first movement prevention part 111C1 may be provided on a case first area 101 including an area from which lead tabs 140 and 150 are withdrawn (e.g., protrudes therefrom), and a second movement prevention part 111C2 may be provided on a case second area 102 without the lead tabs. A protruding thickness of the first movement prevention part 111C1 may be greater than that of the second movement prevention part 111C2. In some embodiments, the most vulnerable portion when the secondary battery drops is the lead tabs 140 and 150 and/or edges of the case. Therefore, in some embodiments, the protrusion thickness of the first movement prevention part 111C1 on the area corresponding to the vulnerable portion may be configured to be larger than the protrusion thickness of the second movement prevention part 111C2, thereby reinforcing the portion that is vulnerable when the secondary battery is dropped.

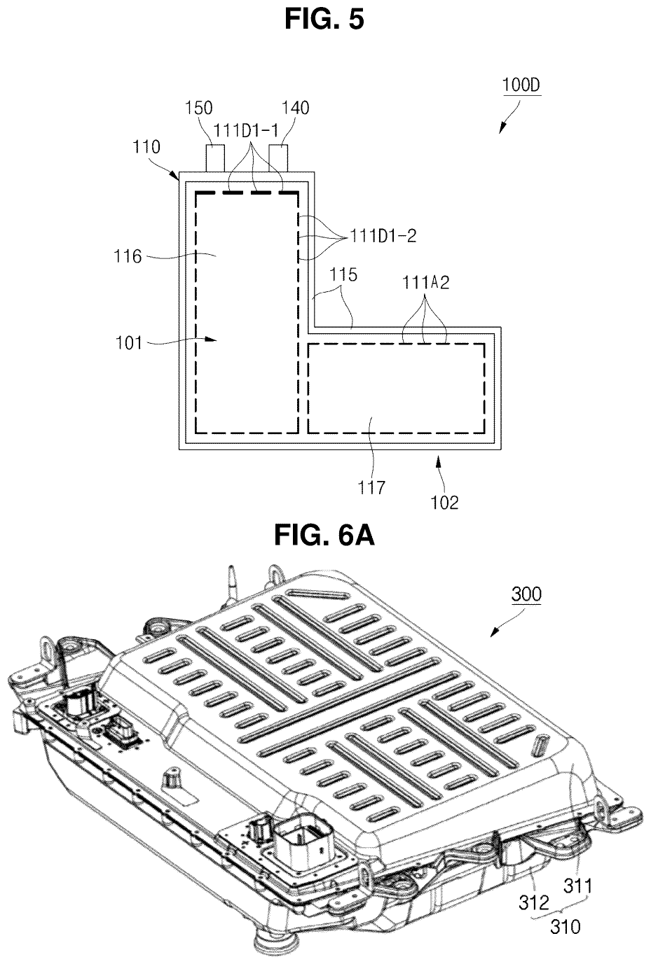

FIG. 5 illustrates a plan view of a secondary battery 100D according to some embodiments. The secondary battery 100D illustrated in FIG. 5 may be similar to the secondary battery 110A illustrated in FIG. 2. However, the movement prevention part provided in the case first area 101 may include a first movement prevention part 111D1-1 provided on an area from which lead tabs 140 and 150 are withdrawn, and a second movement prevention part 111D1-2 provided on an area without the lead tabs.

A protruding thickness of the first movement prevention part 111D1-1 may be greater than that of the second movement prevention part 111D1-2. In some embodiments, the movement prevention part provided on the case first area 101 may have a different protruding thickness depending on the position or area. In one or more embodiments, the relatively thick first movement prevention part 111D-1 may be provided at each of the lead tabs 140 and 150 and/or an edge of the case, which are known to be the most vulnerable portions when the secondary battery drops to improve drop reliability of the secondary battery.

The battery according to the above-described embodiments may be used to manufacture a battery pack.

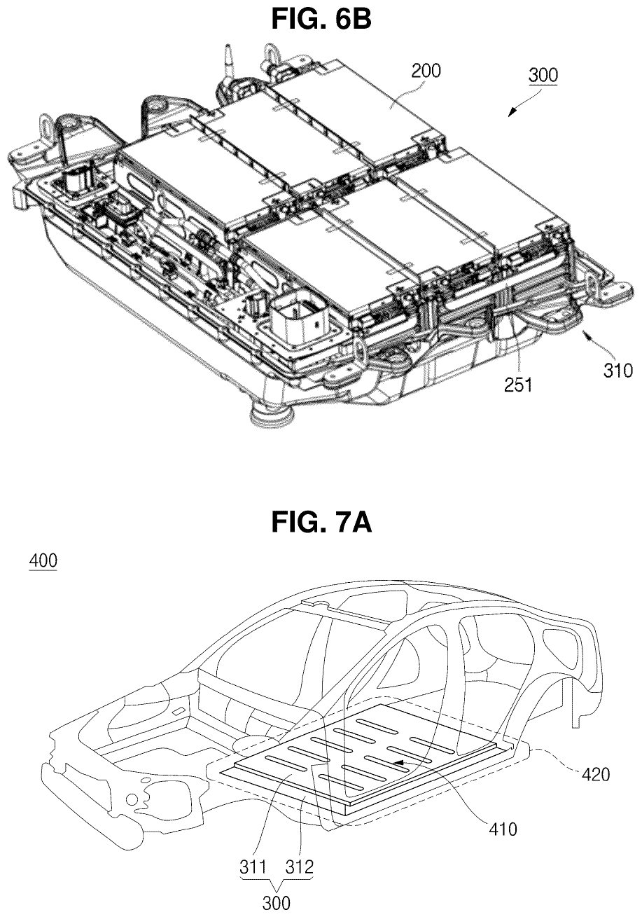

FIGS. 6A and 6B show a battery pack 300 according to one or more embodiments of the present disclosure. The battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. A vehicle may include a four-wheeled vehicle or a two-wheeled vehicle.

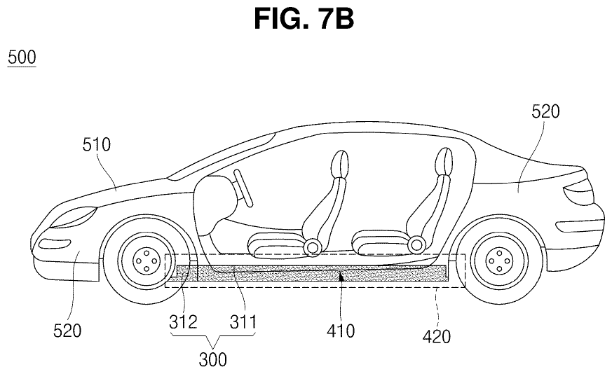

FIGS. 7A and 7B show vehicle body parts 400 and vehicle 500 according to one or more embodiments of the present disclosure including the battery pack 300 shown in FIGS. 6A and 6B.

In FIG. 7A, a battery pack 300 may include a battery pack cover 311, which is a part of a vehicle underbody 410 and may correspond to the first housing, and a pack frame 312, which is disposed under the vehicle underbody 410 and may corresponding to the second housing. The battery pack cover 311 and the pack frame 312 may be integrally formed with a vehicle floor 420. The vehicle underbody 410 separates the inside and outside of a vehicle, and the pack frame 312 may be disposed outside the vehicle.

In FIG. 7B, a vehicle 500 may be formed by combining additional parts, such as a hood 510 in front of the vehicle 500 and fenders 520 respectively located in the front and rear of the vehicle 500 to a vehicle body pars 400. The vehicle 500 may include the battery pack 300 including the battery pack cover 311 and the pack frame 312, and the battery pack 300 may be coupled to the vehicle body part 400.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

The present disclosure may provide the secondary battery that prevents the electrode body from moving within the case when dropped. For example, the present disclosure may provide a movement prevention part in the form of the dotted line that protrudes toward the electrode body at the portion of the case corresponding to the perimeter of the electrode body to prevent the electrode body from moving inside the case when the secondary battery drops. The electrode body may be prevented from moving inside the case when dropped such that fires due to the internal short circuit of the electrode body may be prevented from occurring.

However, aspects and features of the present disclosure are not limited to those described above, and other aspects and features not mentioned will be clearly understood by a person skilled in the art from the detailed description, described above.

As described above, while the embodiments of the present disclosure have been described with reference to the specific embodiments, it will be apparent to those skilled in the art that various changes and modifications may be made without departing from the spirit and scope of the invention as defined in the following claims.

What is claimed is:

1. A secondary battery comprising:
a housing comprising a first case and a second case, the second case coupled to the first case;
an electrode body accommodated in the housing; and
a lead tab protruding outward from the electrode body, through one side of the housing, to the outside of the housing, wherein at least one of the first case or the second case comprises a movement prevention part configured to prevent the electrode body from moving.

2. The secondary battery as claimed in claim 1, wherein the movement prevention part is provided on a partial area of the housing corresponding to a perimeter of the electrode body.

3. The secondary battery as claimed in claim 1, wherein the movement prevention part comprises a dimple or an embossing that protrudes toward the inside of the housing.

4. The secondary battery as claimed in claim 1, wherein the movement prevention part is provided in the form of a dotted line, a dashed line, a long-dashed line, a dash-single dotted line, and/or a dash-double dotted line.

5. The secondary battery as claimed in claim 1, wherein the movement prevention part is provided such that the movement prevention part crosses the electrode body.

6. The secondary battery as claimed in claim 1, wherein at least two lines of the movement prevention part are provided such that the at least two lines of the movement prevention part cross the electrode body.

7. The secondary battery as claimed in claim 1, wherein the housing comprises:
a case first area extending in a first direction; and
a case second area extending in a second direction perpendicular to the first direction.

8. The secondary battery as claimed in claim 7, wherein the electrode body comprises:
an electrode body first area accommodated in the case first area; and
an electrode body second area accommodated in the case second area.

9. The secondary battery as claimed in claim 7, wherein the movement prevention part is provided along a perimeter of the sum of the case first area and the case second area.

10. The secondary battery as claimed in claim 7, wherein the movement prevention part comprises:
a first movement prevention part provided along a perimeter of the case first area; and
a second movement prevention part spaced apart from the first movement prevention part and provided along a perimeter of the case second area.

11. The secondary battery as claimed in claim 7, wherein the movement prevention part is provided on either the case first area or the case second area.

12. The secondary battery as claimed in claim 7, wherein the movement prevention part comprises:
a first movement prevention part provided on the case first area from which the lead tab is withdrawn; and
a second movement prevention part provided on the case second area without the lead tab,
wherein a protruding thickness of the first movement prevention part is greater than a protruding thickness of the second movement prevention part.

13. The secondary battery as claimed in claim 12, wherein the first movement prevention part extends from a partial area of the case first area to a partial area of the case second area.

14. The secondary battery as claimed in claim 1, wherein the housing comprises stainless steel.

15. The secondary battery as claimed in claim 1, wherein the first case comprises a first flange provided along a perimeter thereof; and
a second case comprises a second flange provided along a perimeter thereof, wherein the first flange and the second flange are welded to each other.
